(19) United States
(12) Patent Application Publication
(10) Pub. No.: US 2024/0400778 A1
(43) Pub. Date: Dec. 5, 2024

(54) RIGID POLYURETHANE FOAMS COMPRISING A SILOXANE RICH NUCLEATING AGENT

(71) Applicant: MOMENTIVE PERFORMANCE MATERIALS INC., Waterford, NY (US)

(72) Inventors: Pierre CHAFFANJON, Leverkusen (DE); Yevgen BEREZHANSKYY, Parkersburg, WV (US); Robin HEEDFELD, Leverkusen (DE)

(21) Appl. No.: 18/804,923

(22) Filed: Aug. 14, 2024

Related U.S. Application Data
(63) Continuation of application No. 17/295,071, filed on May 19, 2021.
(60) Provisional application No. 62/769,060, filed on Nov. 19, 2018.

(51) Int. Cl. C08J 9/00; C08G 18/08; C08G 18/16; C08G 18/42; C08G 18/61; C08G 18/76; C08G 77/46; C08J 9/12

(52) U.S. Cl. CPC C08J 9/0042; C08G 18/14; C08G 18/168; C08G 18/4208; C08G 18/61; C08G 18/7657; C08G 77/46; C08J 9/0061; C08J 9/125; C08G 2110/0016; C08G 2110/0025; C08G 2110/005; C08G 2110/0058; C08G 2330/00; C08J 2203/10; C08J 2375/04

(57) ABSTRACT

The present technology provides a method of manufacturing a polyurethane foam having a low thermal conductivity from a foam formulation comprising a polyol, an isocyanate, a polyurethane catalyst, a surfactant, water, and a siloxane rich composition. The siloxane rich composition may act as a nucleating agent to reduce the cell size of the foams and may reduce its thermal conductivity.

### CROSS-REFERENCE TO RELATED APPLICATIONS

This application is a continuation of and claims priority to and the benefit of U.S. patent application Ser. No. 17/295,071 filed on May 19, 2021, which is a 35 U.S.C. § 371 national stage application of PCT Application No. PCT/US2019/061387 filed on Nov. 14, 2019, entitled “RIGID POLYURETHANE FOAMS COMPRISING A SILOXANE RICH NUCLEATING AGENT,” which claims priority to and the benefit of U.S. Provisional Application 62/769,060 titled “Rigid Polyurethane Foams Comprising a Siloxane Rich Nucleating Agent” filed on Nov. 19, 2018, the disclosure of which is incorporated by reference herein in its entirety.

### FIELD

The present technology relates generally to polyurethane foam compositions and foams made from such compositions. More particularly, the present technology relates to rigid or semi-rigid polyurethane foams employing particular molecular weight siloxane rich compounds as a nucleating agent.

### BACKGROUND

Rigid polyurethane foams split in two categories, PUR and PIR types. Rigid PUR foams are made with a low isocyanate excess and contain predominantly urethane and urea bonds formed from the isocyanate reaction. Rigid PIR foams are made with a large excess of isocyanate and lead to a significant amount of isocyanurate bonds resulting from the isocyanate trimerization reaction, additional to urethane and urea bonds. Both foam types are widely used as insulating materials in the construction industry and for domestic or commercial refrigeration. These foams display excellent insulation characteristics.

Conventional rigid polyurethane foam, such as may be used in insulating applications, is generally prepared by the reaction of at least one polyol with at least one isocyanate in the presence of suitable catalysts, surfactants, chemical and/or physical blowing agents and optionally other additives such as fire retardants or other processing or foam property improving additives.

Silicone-polyether copolymers are widely used as surfactant in such rigid polyurethane foam formulations. Attempts have been made to optimize these types of copolymers to improve or maximize the nucleating effect without compromising on other foam properties. There remains an opportunity to develop a rigid polyurethane foam that has improved thermal conductivity properties for use in insulating applications.

### SUMMARY

The present technology provides a siloxane based additive composition to be used in semi-rigid or rigid polyurethane foam formulations to provide improved thermal conductivity.

In one aspect, the present technology provides a rigid polyurethane or polyisocyanurate foam composition comprising a polyol or a mixture thereof, an isocyanate, a polyurethane catalyst or a mixture thereof, a surfactant, a siloxane rich composition, a blowing agent being either water, a physical blowing agent or a mixture thereof, or a combination of both, optionally a co-chemical blowing agent or a mixture thereof, optionally a fire retardant additive or a mixture thereof, and optionally other processing additives. It has been found that the use of specific molecular weight, siloxane rich materials may serve as nucleating agents when used in combination with conventional rigid foam surfactants and especially those being based on silicone-polyether copolymers. Applicant has found that using these siloxane rich materials of a certain molecular weight and/or molecular weight distribution can have a positive nucleating effect at the initial mixing stage without leading to de-foaming or lack of cell size control at a later reaction stage, therefore providing foams with low cells size, leading to low foam thermal conductivity.

In one embodiment, provided is a composition comprising a siloxane rich compound of the formula:

M³ₐD³_{b}D⁴_{c}T_{d}Qₑ (II)

where
M³ is a trialkyl end-cap unit R³R⁴R⁵SiO_{1/2}—;
D³ is a dialkyl unit —O_{1/2}R⁶R⁷SiO_{1/2}—;
D⁴ is a alkyl unit —O_{1/2}R⁸R⁹SiO_{1/2}—; T is —O_{1/2}Si(O_{1/2}—)₂R¹⁰;
Q is Si(O_{1/2}—)₄;
R³, R⁴, R⁶, R⁷, R⁸, and R¹⁰ are independently fluorine, phenyl, or C1 to C10 alkyl groups, eventually fluorine or phenyl partially or fully substituted;
R⁵ is fluorine; phenyl; or C1 to C10 alkyl groups optionally partially or fully substituted with fluorine or phenyl; or —R¹¹—Oₘ—(CH₂—CH₂—O), (CH₂—CH(CH₃)—O)ₚ—R¹²;
R⁹ is —R¹¹—Oₘ—(CH₂—CH₂—O)_{q}(CH₂—CH(CH₃)—O)ₚ—R¹²;
R¹¹ is C1 to C10 hydrocarbon group;
R¹² is hydrogen, phenyl, fluorine, or a C1-C8 hydrocarbon group, in embodiments fluorine or phenyl partially or fully substituted and optionally interrupted by urethane, urea or carbonyl groups;
a and b are independently from 0 to 30;
c, d, and e are independently from 0 to 5;
m is 0 or 1;
q and p are independently from 0 to 10;
with the condition that b +c is at least 1;
with the proviso that the siloxane rich compound has a silicon content by weight of at least 25%.

In one embodiment, the siloxane rich compound or mixture of has a number average molecular weight between 200 and 3000 dalton.

In one embodiment, the siloxane rich compound or mixture of has a number average molecular weight between 300 and 2500 dalton.

In one embodiment, the siloxane rich compound or mixture of has a number average molecular weight between 450 and 2000 dalton.

In one embodiment of the composition of any previous embodiment, the siloxane rich compound or mixture of has a silicon content by weight above 28%.

In one embodiment of the composition of any previous embodiment, the siloxane rich compound or mixture of has a silicon content by weight above 25% and up to about 32% by weight.

In one embodiment of the composition of any previous embodiment, the siloxane rich compound or mixture of has on average 2 or less reactive groups per molecule that can react with isocyanate.

In one embodiment of the composition of any previous embodiment, the siloxane rich compound or mixture of has on average less than 2 or no reactive groups that can react with isocyanate.

In one embodiment of the composition of any previous embodiment, subscript a of the siloxane rich compound is at least equal to 1.

In one embodiment of the composition of any previous embodiment, the subscript a is 1 to 30; 2 to 20; or 2 to 10.

In one embodiment of the composition of any previous embodiment, the siloxane rich composition is based on a distribution of molecular weight that contains 2.5% or less of siloxane based species having a molecular weight below 400.

In one embodiment of the composition of any previous embodiment, the siloxane rich composition is based on a distribution of molecular weight that contains 2.5% or less of siloxane based species having a number average molecular weight below 400; below 350; below 300; or below 250.

In one embodiment of the composition of any previous embodiment, the siloxane rich composition contains about 5% or less of cyclic siloxane species containing 3 to 6 siloxane groups, commonly named D3, D4 and D6; 3.5% or less; 2.5% or less; 1% or less; or 0.5% or less.

In one aspect, provided is a foam formulation comprising a polyol; an isocyanate; a catalyst; a surfactant; a physical blowing agent; and a siloxane rich composition of in accordance with any of the previous embodiments.

In another aspect, provided is a process for producing a polyurethane foam by reacting the different components of a formulation comprising: a polyol; an isocyanate; a catalyst; a surfactant; a physical blowing agent; and a siloxane rich composition of in accordance with any of the previous embodiments.

In one embodiment, the siloxane rich composition or mixture is used in an amount of at least 0.02% by weight over the total formulation components weight excluding physical blowing agents.

In one embodiment of the process of any previous embodiment, the siloxane rich composition or mixture is present in an amount of at least 0.03% by weight over the total formulation components weight excluding physical blowing agents.

In one embodiment of the process of any previous embodiment, the siloxane rich composition or mixture is present in an amount of at least 0.05% by weight over the total formulation components weight excluding physical blowing agents.

In one embodiment of the process of any previous embodiment, the siloxane rich composition or mixture is present in an amount of 3% by weight or lower over the total formulation components weight excluding physical blowing agents.

In one embodiment of the process of any previous embodiment, the siloxane rich composition or mixture is present in an amount of about 0.05% by weight to about 3% by weight over the total formulation components weight excluding physical blowing agents.

In one embodiment of the process of any previous embodiment, the siloxane rich composition or mixture of is added in a formulated pre-blend to be mixed with a isocyanate component to produce a polyurethane foam used as thermal insulation material.

In one embodiment of the process of any previous embodiment, the siloxane rich composition or mixture of is added as a separate component on a foam dispensing unit to produce a polyurethane foam used as thermal insulation material.

In one embodiment of the process of any previous embodiment, the siloxane rich composition or mixture of is added to an isocyanate component to be mixed with isocyanate reactive ingredients to produce a polyurethane foam used as thermal insulation material.

In one embodiment of the process of any previous embodiment, the siloxane rich composition or mixture of is added in the polyurethane foam formulation in addition to a surfactant, optionally siloxane containing, with the siloxane containing portion of such surfactant if present having a silicon content lower than 25% and a number average molecular weight above 2000 dalton.

In one embodiment of the process of any previous embodiment, the polyol is selected from polyester polyols, polyether polyols, polycarbonate polyols, polythioether polyols, polycaprolactones, brominated polyether polyols, acrylic polyols, or a combination of two or more thereof.

In one embodiment of the process of any previous embodiment, the catalyst package is made of a tertiary amine providing blowing and gelation catalytic activity and optionally a trimerization catalyst providing isocyanurate catalytic activity.

In one embodiment of the process of any previous embodiment, the physical blowing agent is selected from hydrocarbon and in particular pentane and any isomer mixture of, hydrofluorocarbons, hydrofluoroolefins, hydrochlorofluorocarbons, hydrochlorofluoroolefins and any combination thereof.

In one embodiment of the process of any previous embodiment, the process forms a rigid or semi-rigid polyurethane foam. In one embodiment, the rigid or semi-rigid polyurethane foam has a density between 10 and 100 kg/m³ and at an isocyanate index between 100 and 500.

In one embodiment, the foam is used as a thermal insulation material

In one embodiment, the foam has an initial thermal conductivity of about 23 mW/m·K or less at a mean temperature of 0 to 30° C.

In still another aspect, provided is an article comprising the polyurethane foam formed from the process.

In one aspect, provided is a polyurethane or polyisocyanurate foam formed from the composition of any of the previous embodiments.

In one embodiment, the isocyanate composition of the foam is selected from an aromatic polyisocyanate, an aliphatic polyisocyanate, or any combination thereof.

In one aspect, provided is an article comprising the polyurethane or polyisocyanurate foam of any of the previous embodiments.

In one aspect, provided is a method of forming a polyurethane or polyisocyanurate foam comprising reacting the composition of any of the previous embodiments.

### DETAILED DESCRIPTION

The present technology provides an additive composition to be used in a foam forming formulation and foams made from such formulation. The foam formulations comprise: (a) a polyol component; (b) an isocyanate component; (c) a catalyst component; (d) a surfactant; and (e) a siloxane rich composition. The use of the siloxane rich compositions provides a foam having good properties including, for example, low thermal conductivity. Without being bound to any particular theory, the siloxane rich compositions may serve as a good nucleating agent and allow for controlling or providing a foam with good properties including, for example, low thermal conductivity.

The polyol component is not particularly limited and may be chosen as desired for a particular purpose or intended application. In various embodiments, the polyol may be chosen from polyester polyols, polyether polyols, polycarbonate polyols, hydroxyl-terminated polyolefin polyols etc., or a combination of two or more thereof. The polyols may be, for example, polyester diols, polyester triols, polyether diols, polyether triols, etc. Alternatively, the polyol may be selected from the group of polythioether polyols, polycaprolactones, brominated polyether polyols, acrylic polyols, etc., or a combination of two or more thereof. When high functionality polyether polyols are used, the high functionality polyether polyol may have a functionality from about 3 to about 6. Polyols such as sucrose or sorbitol initiators may be mixed with lower functionality glycols or amines to bring the functionality of the polyols in the about 3.5 to about 5 range.

Additionally, particularly suitable polyols include aromatic polyester polyol. The aromatic polyester polyol may be prepared from substantially pure reactant materials or more complex starting materials, such as polyethylene terephthalate, may be used. Additionally, dimethyl terephthalate (DMT) process residues may be used to form aromatic polyester polyol.

The aromatic polyester polyol may comprise halogen atoms. It may be saturated or unsaturated. The aromatic polyester polyol may have an aromatic ring content that is at least about 30 percent by weight, based on the total compound weight, at 35 percent by weight, even about 40 percent by weight. Here as elsewhere in the specification and claims, numerical values may be combined to form new or undisclosed ranges. Polyester polyols having an acid component that advantageously comprises at least about 30 percent by weight of phthalic acid residues, or residues of isomers thereof, are particularly useful.

The aromatic polyester polyol may have a hydroxyl number greater than about 50 mg KOH/g, greater than about 100 mg KOH/g, greater than about 150 mg KOH/g, greater than about 200 mg KOH/g and greater than about 250 mg KOH/g. In one embodiment, the aromatic polyester polyol has a hydroxyl number of from about 100 mg KOH/g to about 300 mg KOH/g. Here as elsewhere in the specification and claims, numerical values may be combined to form new and non-disclosed ranges.

In one embodiment, the aromatic polyester polyol has a functionality that is greater than about 1, or greater than about 2. In one embodiment, the aromatic polyester polyol has a functionality of from about 1 to about 4, or from about 1 to about 2. Here as elsewhere in the specification and claims, numerical values may be combined to form new and non-disclosed ranges.

The foam composition also includes an isocyanate composition. The isocyanate may include at least one isocyanate and may include more than one isocyanate. The isocyanate may be selected from an aromatic isocyanate, an aliphatic isocyanate, or any combination thereof. The isocyanate composition may include an aromatic isocyanate such as polymeric MDI. If the isocyanate composition includes an aromatic isocyanate, the aromatic isocyanate may correspond to the formula R¹(NCO)z where R¹ is a polyvalent organic radical which is aromatic and z is an integer that corresponds to the valence of R¹. Generally, z is at least 2.

The isocyanate composition may include, but is not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4-and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and any combination thereof.

The foam composition also includes one or more catalysts. The catalyst is not particularly limited and may be chosen from any catalyst material suitable for catalyzing the reaction between an hydroxyl group from either water, a polyol or any hydroxyl terminated compound and an isocyanate to form an expanded thermoset polyurethane based polymer. Examples of suitable catalysts are selected from but are not limited to, a gelation catalyst and or a blowing catalyst, and or a trimerization catalyst. Specifically, a gelation catalyst may catalyze the hydroxyl to isocyanate reaction to generate a urethane bond. A blowing catalyst may promote a water to isocyanate reaction to generate a urea bond. A trimerization catalyst may promote a reaction of three isocyanate groups to form an isocyanurate bond. The catalyst may include one or more catalysts and typically includes a combination of catalysts. The catalyst may or may not be consumed in the exothermic reaction depending if it contains a isocyanate reactive group or not. The catalyst may include any suitable catalyst or mixtures of catalysts known in the art. Examples of suitable catalysts include, but are not limited to, amine catalysts in appropriate diluents, e.g., dipropylene glycol; and metal catalysts, e.g., tin, bismuth, lead, etc. If included, the catalyst may be included in various amounts. In one embodiment, the catalyst is selected from the group of, N,N-dimethylcyclohexylamine (DMCHA), N,N,N′,N′,N″-pentamethyldiethylenetriamine (PMDETA), bis-(2-dimethylaminoethyl) ether, amidines such as 2,3-dimethyl-3,4,5,6-tetrahydropyrimidine, other tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetamethylhexane-1,6-diamine, mono or bis (dimethylaminopropyl) urea dimethylpipcrazine, 1,2-dimethylimidazole, 1-azabicyclo [3.3.0] octane, 1,4-diazabicyclo [2.2.2] octane, alkanolamine compounds such as triethanolamine, triisopropanolamine, N-methyldiethanolamine, N-ethyldiethanolamine, dimethylethanolamine, tris(dialkylaminoalkyl)-s-hexahydrotriazines, including tris(N,N-dimethylaminopropyl)-s-hexahydrotriazine, tetraalkylammonium hydroxides including tetramethylammonium hydroxide, quaternary ammonium carboxylate salts, tetramethylammonium acrylate, tetraethylammonium, acrylate, tetrapropylammonium acrylate, tetrabutylammonium acrylate, (2-hydroxypropyl)trimethylammonium formate, (2-hydroxypropyl)trimethylammonium 2-ethylhexanoate, tetramethylammonium pivalate, tetraethylammonium pivalate, tetrapropylammonium pivalate, tetrabutylammonium pivalate, tetramethylammonium triethylacetate, tetraethylammonium triethylacetate, tetrapropylammonium triethylacetate, tetrabutylammonium triethylacetate, tetramethylammonium neoheptanoate, tetraethylammonium neoheptanoate, tetrapropylammonium neoheptanoate, tetrabutylammonium neooctanoate, tetraethylammonium neoheptanoate, tetramethylammonium neooctanoate, tetrapropylammonium neooctanoate, tetrabutylammonium neooctanoate, tetramethylammonium neodecanoate, tetraethylammonium neodecanoate, tetrapropylammonium neodecanoate, tetrabutylammonium neodecanoate, alkali metal hydroxides including sodium hydroxide and potassium hydroxide, alkali metal alkoxides including sodium methoxide and potassium isopropoxide, alkali metal salts of long-chain fatty acids having from 5 to 20 carbon atoms and/or lateral hydroxyl groups, tin, iron, lead, bismuth, mercury, titanium, hafnium, zirconium, iron(II) chloride, zinc chloride, lead octoate stabilized stannous octoate, tin(II) salts of organic carboxylic acids such as tin(II) acetate, tin(II) octoate, tin(II) ethylhexanoate and tin(II) laurate, and dialkyltin(IV), salts of organic carboxylic acids such as dibutyltin dilaurate, dibutyltin diacetate, dibutyltin maleate and dioctyltin diacetate, potassium salts including potassium formate, potassium acetate, potassium propionate, potassium butanoate, potassium, pentanoate, potassium hexanoate, potassium heptanoate, potassium octoate, potassium 2-ethylhexanoate, potassiumdecanoate, potassium butyrate, potassium isobutyrate, potassium nonante, potassium stearate, 2-hydroxypropyltrimethylammonium octoate solution, sodium salts like, sodium octoate, sodium acetate, sodium caprioate, lithium salts like, lithium stearate, lithium octoate, and the like, or any combination thereof. In various embodiments, the catalyst may be included in amounts of from 0.5 to 8 weight percent of the total foam composition. Here as elsewhere in the specification and claims, numerical values may be combined to form new or undisclosed ranges.

The foam compositions includes a surfactant. The surfactant may be any surfactant suitable for use in the production of rigid foams (e.g., including those that may contribute to control or regulate the cell size). Examples of such surfactants are the sodium salt of a castor oil sulphonate, a sodium salt of a fatty acid, a salt of a fatty acid with an amine, an alkali metal or ammonium salt of a sulphonic acid, a polyether siloxane copolymer, or a mixture of two or more thereof. In one aspect, the composition includes a silicone surfactant, and particularly a silicone-polyether type surfactant. Other types of surfactants, e.g., a non-silicone surfactant, or a combination of both may be employed. In one embodiment, the surfactant may include non-ionic surfactants, cationic surfactants, anionic surfactants, amphoteric surfactants, and combinations thereof. In various embodiments, the surfactant may include, but is not limited to, polyoxyalkylene polyol surfactants, alkylphenol ethoxylate surfactants, and combinations thereof. In one embodiment, the salts of sulfonic acids, e.g., alkali metal and/or ammonium salts of oleic acid, stearic acid, dodecylbenzene-disulfonic acid or dinaphthylmethane-disulfonic acid, and ricinoleic acid, and other organopolysiloxanes, oxyethylated alkyl-phenols, oxyethylated fatty alcohols, paraffin oils, castor oil, castor oil esters, and ricinoleic acid esters, and cell regulators, such as fatty alcohols, and combinations thereof.

In one embodiment, the surfactant is selected from the group of silicone surfactants. Generally, silicone surfactants may control cell size, closed cell content, flow and limit voids formation in the rigid foam produced from the reaction of the resin composition and isocyanate composition. Examples of suitable surfactants include silicone-polyether type surfactants including those of the formula:

M¹D¹ₓD²_{y}M² (I)

wherein, M¹ and M² independently represents (CH₃)₃SiO_{1/2}, or (CH₃)₂R¹SiO_{1/2},
D¹ represents (CH₃)₂SiO_{2/2},
D² represents (CH₃)R¹SiO_{2/2},
x+y is usually 10 to 150; y is usually at least 2; the ratio x/y is commonly from 2 to 15; and R¹ is a polyether or mixture of independently selected and which the average has the formula: —CₙH₂ₙO(C₂H₄O)ₜ(C₃H₆O)_{z}R² and possessing a number average molecular weight from 150 to 5000, wherein n is 2 to 4, t is a number such that the oxyethylene residue constitute 40 to 100 percent by the weight of the alkylene oxide residues of the polyoxyalkylene polyether, z is a number such that the propylene oxide residue constitute 60 to 0 percent by the weight of the alkylene oxide residues of the polyoxyalkylene polyether, and R² represents an hydrogen or alkyl group having 1 to 4 carbon atoms or —C(O)CH₃;

The silicone copolymer surfactants can be prepared by several synthetic approaches including staged addition of the polyethers. Moreover, the polyoxyalkylene polyether components are well known in the art and/or can be produced by any conventional process. For instance, hydroxy terminated polyoxyalkylene polyethers which are convenient starting materials in the preparation of the terpolymer can be prepared by reacting a suitable alcohol with ethylene oxide and propylene oxide (1,2-propylene oxide) to produce the polyoxyalkyene polyethers of the desired molecular weights. Suitable alcohols arc hydroxy alkenyl compounds, e.g., vinyl alcohol, allyl alcohol, methallyl alcohol and the like. In general, the alcohol starter preferably is placed in an autoclave or other high-pressure vessel along with catalytic amounts of a suitable catalyst, such as sodium hydroxide, potassium hydroxide, other alkali metal hydroxides, or sodium or other alkali metals Further details of preparation are set forth in, for example, U.S. Pat. No. 3,980,688. The entire contents of which are herein incorporated by reference.

The above-described alcohol-oxide reaction produces a monohydroxy end-blocked polyoxyalkylene polyether in which the other end-blocking group is an unsaturated olefinic group consisting of either a allyl or methallyl or vinyloxy group. These polyethers may be converted to non isocyanate reactive polyoxyalkylene polyethers by capping the hydroxy terminal group of said monohydroxy end-blocked poly (oxyethyleneoxypropylene) copolymers by any conventional means.

The foam composition may comprise two or more different types of silicone surfactants.

Non-limiting examples of suitable conventional silicone surfactants for the foam composition include those available under the Niax® tradename available from Momentive Performance Materials Inc. Suitable surfactants include, but are not limited to, Niax® L-6900, L-5111, L-6972, L-6633, L-6635, L-6190, L-6100, etc., or combinations of two or more thereof.

The surfactant may be present in any appropriate amount. In various embodiments, the surfactant is present in amounts of from 0.5 to 5, of from 1 to 3, or about 2 weight percent of the foam composition. Here as elsewhere in the specification and claims, numerical values may be combined to form new or non-specified ranges.

The foam composition may also include a non-silicone surfactant. The non-silicone surfactant may be used with the silicone surfactants or without. Any surfactant known in the art may be used in the present invention. As such, the surfactant may include non-ionic surfactants, cationic surfactants, anionic surfactants, amphoteric surfactants, and combinations thereof. In various embodiments, the surfactant may include, but is not limited to, polyoxyalkylene polyol surfactants, alkylphenol ethoxylate surfactants, and combinations thereof. If the surfactant is included in the resin composition, the surfactant may be present in any appropriate amount.

The foam composition includes an additive composition comprising defined molecular weight, siloxane rich compound. This additive may also be referred to herein as a siloxane rich composition. The siloxane rich composition may comprise a compound of the formula

M³ₐD³_{b}D⁴_{c}T_{d}Qₑ (II)
where M³ is a trialkyl end-cap unit R³R⁴R⁵SiO_{1/2}—; D³ is a dialkyl unit —O_{1/2}R⁶R⁷SiO_{1/2}—; D⁴ is a alkyl unit —O_{1/2}R⁸R⁹SiO_{1/2}—; T is —O_{1/2}Si(O_{1/2}—)₂R¹⁰; and Q is Si(O_{1/2}—)₄;
R³, R⁴, R⁶, R⁷, R⁸, and R¹⁰ are independently fluorine, phenyl, or C1 to C10 alkyl groups, eventually fluorine or phenyl partially or fully substituted;
R⁵ is fluorine; phenyl; or C1 to C10 alkyl groups optionally partially or fully substituted with fluorine or phenyl; or —R¹¹—Oₘ—(CH₂—CH₂—O)_{q}(CH₂—CH (CH₃)—O)ₚ—R¹²;
R⁹ is —R¹¹—Oₘ—(CH₂—CH₂—O)_{q}(CH₂—CH(CH₃)—O)ₚ—R¹²;
R¹¹ is C1 to C10 hydrocarbon group;
R¹² is hydrogen, phenyl, fluorine, or a C1-C8 hydrocarbon group, in embodients fluorine or phenyl partially or fully substituted and optionally interrupted by urethane, urea or carbonyl groups;
a and b are independently from 0 to 30;
c, d, and e are independently from 0 to 5;
m is 0 or 1;
q and p are independently from 0 to 10;
with the condition that b +c is at least 1;
with the proviso that the siloxane rich compound has a silicon content by weight of at least 25%.

In embodiments, the siloxane rich compound has a number average molecular weight from about 200 to about 3000 dalton; about 300 to about 2500 dalton; about 400 to to about 2000 dalton; about 450 to about 2000 dalton;. Numerical values may be combined to form new and non-specified ranges. Number average molecular weight may be determined by silicon NMR (²⁹Si NMR).

In embodiments, the siloxane rich composition is based on a distribution of molecular weight that contains 2.5% or less of siloxane based species by weight having a molecular weight below 400. In one embodiment, provided is a composition according to any previous embodiment, wherein the siloxane rich composition is based on a distribution of molecular weight that contains 2.5% or less of siloxane based species by weight having a molecular weight below 400; below 350; below 300; or below 250. Molecular weight may be evaluated and quantified using gas chromatography recalculated to weight % using calibration factors.

In embodiments, the siloxane rich composition includes standard low molecular weight cyclic siloxanes having 3 to 6 siloxane units in an amount of about 5% or less; 4% or less; 2.5% or less; 1% or less; or 0.5% or less. In embodiments, the siloxane rich composition has these residual cyclic siloxane species at a very low level below 0.1% each. Typical of such low molecular weight cyclic siloxanes are hexamethylcyclotrisiloxane (D3), octamethylcyclotetrasiloxane (D4), decamethylcyclopentasiloxane (D5), and dodecamethylcyclohexasiloxane (D6).

The silicon content of the siloxane rich composition is at least 25% by weight or greater; at least 28% by weight or greater; at least 30% by weight or greater, up to about 32% by weight.

In one embodiment, the siloxane rich composition has preferably on average 2 or less reactive groups per molecule that can react with isocyanate; 1 or less reactive groups per molecule that can react with isocyanate; or no reactive groups that can react with isocyanate.

In one embodiment, the siloxane rich composition is a polydimethylsiloxane having a number average molecular weight of from about 200 to 3000 Dalton; about 300 to 2500 Dalton; about 450 to 2000 Dalton; with less than 2.5% by weight of species having a molecular weight below 400.

The composition comprising the siloxane rich compounds may comprise a combination of different siloxane rich compounds as described by Formula (II). The siloxane rich compounds are provided in the foam formulation such that the siloxane rich composition on a weight basis over total formulation weight excluding physical blowing agent is from about 0.02% to about 5%; from about 0.03% to about 4%; even from about 0.05% to about 3%.

The siloxane rich composition may be provided as a separate additive or added as part of a composition comprising a surfactant, the siloxane rich composition, and eventually a diluent or another component relevant to incorporate as ingredient in the foam formulation. Examples of suitable diluents include, for example, dipropylene glycol, hexylene glycol, or polymers obtained from alkoxylated initiators of different functionalities from 1 to 10, etc.

The foam composition may also include one or more blowing agents including, but not limited to, physical blowing agents, chemical blowing agents, or any combination thereof. In one embodiment, the blowing agent may include both a physical blowing agent and a co-chemical blowing agent, and the blowing agent may be included in the foam composition. The physical blowing agent does not typically chemically react with the resin composition and/or an isocyanate to provide a blowing gas. The physical blowing agent may be a gas or liquid. A liquid physical blowing agent may evaporate into a gas when heated, and may return to a liquid when cooled. The physical blowing agent may reduce the thermal conductivity of the rigid polyurethane foam. The blowing agent may include, but is not limited methylene chloride, acetone, and liquid carbon dioxide, aliphatic and/or cycloaliphatic hydrocarbons, halogenated hydrocarbons and alkanes, acetals, water, alcohols, formic acid, and any combination thereof. In embodiments, the composition comprises a chemical blowing agent chosen from water, formic acid, or a combination thereof.

In various embodiments, the blowing agent may be selected from hydrocarbons, hydrofluorocarbons, hydrochlorofluoroolefins (HCFO) and hydrofluoroolefins (HFO), volatile non-halogenated C2-C7 hydrocarbons such as alkanes, including N-pentane, isopentane and cyclopentane, alkenes, cycloalkanes having up to 6 carbon atoms, dialkyl ether, cycloalkylene ethers and ketones, and hydrofluorocarbons, C1-C4 hydrofluorocarbons, volatile non-halogenated hydrocarbon such as linear or branched alkanes such as butane, isobutane, 2,3-dimethylbutane, n- and isohexanes, n- and isoheptanes, n- and isooctanes, n- and isononanes, n- and isodecanes, n- and isoundecanes, and n- and isodedecanes, alkenes such as 1-pentene, 2-methylbutene, 3-methylbutene, and 1-hexene, cycloalkanes such as cyclobutane, and cyclohexane, linear and/or cyclic ethers such as dimethyl ether, diethyl ether, methyl ethyl ether, vinyl methyl ether, vinyl ethyl ether, divinyl ether, dimethoxymethane (methylal), tetrahydrofuran and furan, ketones such as acetone, methyl ethyl ketone and cyclopentanone, isomers thereof, ester of carboxylic acids such as methyl methanoate (methyl formate), hydrofluorocarbons such as difluoromethane (HFC-32), 1,1,1,2-tetrafluoroethane (HFC-134a), 1,1,2,2-tetrafluoroethane (HFC-134), 1, 1-difluoroethane (HFC-152a), 1,2-difluoroethane (HFC-142), trifluoromethane, heptafluoropropane (R-227a), hexafluoropropane (R-136), 1,1,1-trifluoro ethane, 1,1,2-trifluoroethane, fluoroethane (R-161), 1,1,1,2,2-pentafluoropropane, pentafluoropropylene (R-2125a), 1,1,1,3-tetrafluoropropane, tetrafluoropropylene (R-2134a), difluoropropylene (R-2152b), 1,1,2,3,3-pentafluoropropane, 1,1,1,3,3-pentafluoro-n-butane, and 1,1,1,3,3-pentafluoropentane (245fa), isomers thereof, 1,1,1,2-tetrafluoroethane (HFC-134a), isomers thereof, and combinations thereof. In various embodiments, the blowing agent may be further defined as 1,1,1,3,3-pentafluoropentane (245fa) or a combination of HFC 245fa, 365MFC, 227ca, and 134a. In an alternative embodiment, the blowing agent may be further defined as 365 MFC, which may be blended with 227ea. In a further embodiment, the blowing agent may be further defined as cis or trans isomer of 1-chloro-3,3,3-trifluoro-propene or 1,1,1 4,4,4 hexafluoro 2-butene, or a combination of these with each other or with any other blowing agent mentioned above.

In various embodiments, the blowing agent may be present in amounts of from 0.1 to 30, of from 1 to 25, of from 2 to 20, of from 3 to 18, of from 5 to 15, weight percent of the foam composition. Here as elsewhere in the specification and claims, numerical values may be combined to form new or undisclosed ranges. Generally, the amount of the blowing agent and/or water may be selected based on a desired density of the rigid foam and solubility of the blowing agent in the resin composition when relevant.

The foam composition may also include a cross-linker and/or a chain extender. The cross-linker may include, but is not limited to, an additional polyol, amines, and any combination thereof. If the cross-linker is included in the foam composition, the cross-linker may be present in any appropriate amount. Chain extenders contemplated for use in the present technology include, but not limited to, hydrazine, primary and secondary diamines, alcohols, amino acids, hydroxy acids, glycols, and combinations thereof. Specific chain extenders that are contemplated for use include, but are not limited to, mono and di-ethylene glycols, mono and di-propylene glycols, 1,4-butane diol, 1,3-butane diol, propylene glycol, dipropylene glycol, diethylene glycol, methyl propylene diol, mono, di-and tri-ethanolamines, N-N′-bis-(2 hydroxy-propylaniline), trimethylolpropane, glycerine, hydroquinone bis (2-hydroxyethyl) ether, 4,4′-methylene-bis (2-chloroaniline, diethyltoluenediamine, 3,5-dimethylthio-toluenediamine, hydrazine, isophorone diamine, adipic acid, silanes, and any combinations thereof.

The foam composition may also include one or more additives. Suitable additives include, but are not limited to, non-reactive fire retardants (e.g., various phosphates, various phosphonates, triethylphosphate, trichloropropylphosphate, triphenyl phosphate, or diethylethylphosphonate, tris(2-chloroethyl)phosphate, tris-ethyl-phosphate, tris(2-chloro-propyl)phosphate, tris(1,3-dichloropropyl)phosphate, diammonium phosphate, various halogenated aromatic compounds, antimony oxide, alumina trihydrate, polyvinyl chloride, and any combinations thereof), OH-free/non-reactive fire retardants, chain terminators, modified or unmodified phenolic resins, inert diluents, amines, anti-foaming agents, air releasing agents, wetting agents, surface modifiers, waxes, inert inorganic fillers, molecular sieves, reactive inorganic fillers, chopped glass, other types of glass such as glass mat, processing additives, surface-active agents, adhesion promoters, anti-oxidants, dyes, pigments, ultraviolet light stabilizers, thixotropic agents, anti-aging agents, anti-static additives, lubricants, coupling agents, solvents, rheology promoters, cell openers, release additives, and combinations thereof. The one or more additives may be present in the foam composition in any amount.

In addition to the foam composition, this technology also provides a method of forming the foam, and a method of forming the foam on a surface.

The method of forming the rigid foam typically includes the step of combining the polyols, the isocyanate composition, the surfactant, the siloxane rich composition and all other additives. The isocyanate index of the foam is generally not limited. Most typically, the polyol and the isocyanate composition are combined such that the isocyanate index is generally above 120 and can go up to 500 or even 600 values depending on the foam to be made, either PUR or PIR type. It will be appreciated by those skilled in the art that the foam may be a polyurethane type foam (PUR, typically index below 200) or a polyisocyanurate (PIR, typically with index well above 200 and usually above 250) foam. It will be appreciated, however, that there is not an absolute value for the index to delineate a PUR foam from a PIR foam.

The method of forming the rigid foam on the surface may include the steps of combining the components to form a foam mixture. Generally, the step of combining may occur in a mixing apparatus such as a static mixer, a mechanical or impingement mixing chamber, or a mixing pump. In one embodiment, the step of mixing occurs in a static mixing tube. Alternatively, the foam composition and the isocyanate composition may be combined in a spray nozzle.

The method of forming the rigid or semi rigid foam may include air nucleation to one or more of the formulation components when processed on industrial mixing equipment.

The components may be combined while on a surface or apart from the surface. In one embodiment, the components may be combined in the head of a spray gun or in the air above the surface to which the composition is being applied. The components may be combined and applied to the surface by any method known in the art including spraying, dipping, pouring, coating, painting, etc.

The present technology provides a semi rigid or rigid polyurethane foam (“rigid or semi-rigid foam”). The rigid foam may be open or closed celled and may include a highly cross-linked, polymer structure that allows the foam to have good heat stability, high compression strength at low density, low thermal conductivity, and good barrier properties. Typically, the rigid foam of this technology may have glass transition temperature greater than room temperature (approximately 23° C.+/−2° C. (approximately 73.4° F.+/−3.6° F.)) and is typically rigid at room temperature. Generally, foams are rigid below their glass transition temperatures especially in glassy regions of their storage moduli. The polyurethane foamed material may have density of from about 10 to about 900 kg/m³, from about 15 to about 800 kg/m³, from about 20 to about 500 kg/m³, from about 30 to about 400 kg/m³. In one embodiment, the rigid foam may have density of from about 10 to about 60 kg/m³, Here as elsewhere in the specification and claims, numerical values may be combined to form new or undisclosed ranges.

The foam mixture may be applied to any appropriate surface, e.g., brick, concrete, masonry, dry-wall, sheetrock, plaster, metal, stone, wood, plastic, a polymer composite, or any combination thereof. Additionally, the surface may be a surface of a mold and, therefore, the rigid foam may be formed in the mold.

The resulting rigid or semi rigid foam may be used in the form of a slabstock, a molding, a panel or a filled cavity. The filled cavity, e.g., may be a pipe, insulated wall, insulated hull structure. The rigid foam may be a sprayed foam, a frothed foam, or a continuously-manufactured laminate product or discontinuously-manufactured laminate product, including but not limited to a laminate or laminated product formed with other materials, such as hardboard, plasterboard, plastics, paper, metal, or a combination thereof.

Rigid foams prepared according to embodiments of the present technology may show improved processability. The present foam may exhibit reduced defects, including, but not limited to, decreased shrinkage and deformation. This characteristic may be useful in the manufacture of sandwich panels. Sandwich panels may comprise at least one relatively planar layer (i.e., a layer having two generally large dimensions and one generally small dimension) of the rigid foam, faced on each of its larger dimensioned sides with at least one layer, per such side, of flexible or rigid material, such as a foil or a thicker layer of a metal or other structure-providing material. Such a layer may, in certain embodiments, serve as the substrate during formation of the foam.

Additionally, the foam mixture produced in the method described above from the above-identified components may have improved thermal insulation, e.g., lower thermal conductivity. In particular, the present compositions employing a siloxane composition of the described structure and with specific molecular weights, may reduce the thermal conductivity of the foam relative to a similar foam composition that is devoid of the described siloxane composition.

Rigid foams comprising the siloxane rich compositions described above may be further understood with reference to the following examples.

### EXAMPLES

### Foam Preparation and Testing Methodology

The foams were generally prepared by first making a resin blend comprising the different polyols, fire retardant, catalysts, and water in a 1 liter plastic cup.

An appropriate weight is used to obtain a sufficient free rise height, maintaining the formulation components ratio as indicated in Tables 1a-1c and 3. The conventional surfactant and the siloxane rich composition are subsequently added either separate or as a mixture in case having of a low level of one prevents good weighing accuracy. In both cases they are gently mixed with a spatula until achieving homogeneity of the pre-mix blend. The physical blowing agent is a pentane isomer or mixture of and is added to this resin blend to the target weight, then gently mixed with a spatula until achieving homogeneity of the pre-mix blend. A small quantity of extra pentane is added until the required weight to correct for small quantity lost from evaporation during the mixing is obtained. This is repeated until the required weight is reached and stable. The resulting mixture is further mixed using a mechanical mixer at 4000 rpm for 10 seconds. The required amount of isocyanate is pre-weighted in another cup and quickly added to the cup containing the polyol-pentane pre-mix to provide a reactive blend. The reactive blend is further mixed at 4000 rpm for 5 seconds using a high energy mechanical mixer equipped with a 6 cm circular propeller and poured immediately after end of mixing in a square open paper cup mold of 23×23 cm section and 20 cm height enclosed on the sides in a square wooden frame. Pouring is done in the middle of the square section. The foam expands freely in the vertical direction. Cream time and gel time are measured from the remaining reactive material in the cup. A rigid free rise foam is obtained and left for cooling and cured for the next 24 hours at room temperature within the open paper mold.

A piece of the foam is then cut after 24 hours from the center of the block of dimension 20×20×4 cm and evaluated for thermal conductivity. This piece is used to measure core foam density measurement and thermal conductivity (also named lambda value) between either 0° C. and 20° C. (10° C. mean temperature) or 10 and 36° C. (23° C. mean temperature) using a FOX Lasercomp 200 heat flow meter. The recorded value is referred as initial thermal conductivity.

### Raw Materials Used in the Compositions

Stepanpol PS 2412 is an aromatic polyester polyol obtained from Stepan Voranol. RN411 is a polyether polyol obtained from Dow Chemicals. Daltocel R585 is a polyether polyol obtained from Huntsman Co. TCPP liquid fire retardant is (tris (1-chloro-2-propyl) phosphate. Niax A-1, C-5, C-8, and potassium octoate are commercial catalysts from the Momentive Urethane Additives portfolio. Desmodur 44V70L and Suprasec 5025 are polymeric MDI grades obtained from Covestro and Huntsman Co, respectively.

Tables 1a-1c show a typical formulation for PIR foams, e.g., foams made with a formulation where the isocyanate index is typically above 200. For the experiments listed, an index of 300 was selected, a typical value used for PIR foams, for instance, for construction panels either flexible or metal faced. The blowing agent used is n-pentane and the lambda value was measured at a mean temperature of 10° C., between 0° C. and 20° C. plate temperatures.

TABLE 1a

| Foam | | | | | | | |
|---|---|---|---|---|---|---|---|
| Formulation | 1a | 1b | 1c | 2 | 3 | 4 | 5 |
| Aromatic | 100 | 100 | 100 | 100 | 100 | 100 | 100 |
| polyester | | | | | | | |
| polyol, | | | | | | | |
| Stepanpol PS | | | | | | | |
| 2412 | | | | | | | |
| TCPP liquid | 15.0 | 15.0 | 15.0 | 15.0 | 15.0 | 15.0 | 15.0 |
| fire retardant | | | | | | | |
| Water | 0.8 | 0.8 | 0.8 | 0.8 | 0.8 | 0.8 | 0.8 |
| Niax catalyst | 0.25 | 0.25 | 0.25 | 0.25 | 0.25 | 0.25 | 0.25 |
| C-5 | | | | | | | |
| Niax | 2.5 | 2.5 | 2.5 | 2.5 | 2.5 | 2.5 | 2.5 |
| potassium | | | | | | | |
| octoate | | | | | | | |
| Conventional | 1.6 | 1.6 | 1.6 | 2.8 | 5 | 1.6 | 1.6 |
| rigid foam | | | | | | | |
| silicone | | | | | | | |
| stabilizer | | | | | | | |
| n-pentane | 20 | 20 | 20 | 20 | 20 | 20 | 20 |
| Polymeric | 218 | 218 | 218 | 218 | 218 | 218 | 218 |
| MDI, | | | | | | | |
| Desmodur | | | | | | | |
| 44V70L | | | | | | | |
| Added | | | | | | 0.2 | 1.2 |
| siloxane | | | | | | | |
| composition 1 | | | | | | | |
| Added | | | | | | | |
| siloxane | | | | | | | |
| composition 2 | | | | | | | |
| Added | | | | | | | |
| siloxane | | | | | | | |
| composition 3 | | | | | | | |
| Added | | | | | | | |
| siloxane | | | | | | | |
| composition 4 | | | | | | | |
| Added | | | | | | | |
| siloxane | | | | | | | |
| composition 5 | | | | | | | |
| Added | | | | | | | |
| siloxane | | | | | | | |
| composition 6 | | | | | | | |
| Added | | | | | | | |
| siloxane | | | | | | | |
| composition 7 | | | | | | | |
| Added | | | | | | | |
| siloxane | | | | | | | |
| composition 8 | | | | | | | |
| Weight | — | — | — | — | — | 100 | 100 |
| siloxane | | | | | | | |
| compound in | | | | | | | |
| added | | | | | | | |
| siloxane | | | | | | | |
| based | | | | | | | |
| composition | | | | | | | |
| (%) | | | | | | | |
| Siloxane | | | | | | | |
| compound, | | | | | | | |
| calculated | | | | | | | |
| parameters | | | | | | | |
| Silicon % * | — | — | — | — | — | 37.05 | 37.05 |
| Average | — | — | — | — | — | 630 | 630 |
| molecular | | | | | | | |
| weight * | | | | | | | |
| Average | — | — | — | — | — | 0 | 0 |
| number of | | | | | | | |
| reactive | | | | | | | |
| group/molecule* | | | | | | | |
| Added | 0 | 0 | 0 | 0 | 0 | 0.06 | 0.35 |
| siloxane | | | | | | | |
| compound | | | | | | | |
| over total | | | | | | | |
| formulation** (%) | | | | | | | |
| Isocyanate | 300 | 300 | 300 | 300 | 300 | 300 | 300 |
| index | | | | | | | |
| Reactivity - | 60 | 65 | 57 | 58 | 63 | 62 | 60 |
| Gel time (s) | | | | | | | |
| Foam density | 33 | 32 | 33 | 31 | 32 | 32 | 30 |
| (kg/m³) | | | | | | | |
| Cell | controlled | controlled | controlled | controlled | controlled | controlled | Controlled |
| size/structure | | | | | | | |
| Thermal | | | | | | | |
| conductivity | | | | | | | |
| after 24 hours | | | | | | | |
| (Lambda | 24.1 | 24.4 | 24.21 | 24.36 | 23.81 | 23.42 | 23.03 |
| 0-20° C., in | | | | | | | |
| mW/K.m) | | | | | | | |

TABLE 1b

| Foam | | | | | | | | |
|---|---|---|---|---|---|---|---|---|
| Formulation | 6 | 7 | 8 | 9 | 10 | 11 | 12 | 13 |
| Aromatic | 100 | 100 | 100 | 100 | 100 | 100 | 100 | 100 |
| polyester | | | | | | | | |
| polyol, | | | | | | | | |
| Stepanpol PS | | | | | | | | |
| 2412 | | | | | | | | |
| TCPP liquid | 15.0 | 15.0 | 15.0 | 15.0 | 15.0 | 15.0 | 15.0 | 15.0 |
| fire retardant | | | | | | | | |
| Water | 0.8 | 0.8 | 0.8 | 0.8 | 0.8 | 0.8 | 0.8 | 0.8 |
| Niax catalyst | 0.25 | 0.25 | 0.25 | 0.25 | 0.25 | 0.25 | 0.25 | 0.25 |
| C-5 | | | | | | | | |
| Niax | 2.5 | 2.5 | 2.5 | 2.5 | 2.5 | 2.5 | 2.5 | 2.5 |
| potassium | | | | | | | | |
| octoate | | | | | | | | |
| Conventional | 1.6 | 1.6 | 1.6 | 1.6 | 1.6 | 1.6 | 1.6 | 1.6 |
| rigid foam | | | | | | | | |
| silicone | | | | | | | | |
| stabilizer | | | | | | | | |
| n-pentane | 20 | 20 | 20 | 20 | 20 | 20 | 20 | 20 |
| Polymeric | 218 | 218 | 218 | 218 | 218 | 218 | 218 | 218 |
| MDI, | | | | | | | | |
| Desmodur | | | | | | | | |
| 44V70L | | | | | | | | |
| Added | 5 | | | | | | | |
| siloxane | | | | | | | | |
| composition 1 | | | | | | | | |
| Added | | 0.2 | 1.2 | 5 | | | | |
| siloxane | | | | | | | | |
| composition 2 | | | | | | | | |
| Added | | | | | 1.2 | | | |
| siloxane | | | | | | | | |
| composition 3 | | | | | | | | |
| Added | | | | | | 1.2 | 5 | |
| siloxane | | | | | | | | |
| composition 4 | | | | | | | | |
| Added | | | | | | | | 0.2 |
| siloxane | | | | | | | | |
| composition 5 | | | | | | | | |
| Added | | | | | | | | |
| siloxane | | | | | | | | |
| composition 6 | | | | | | | | |
| Added | | | | | | | | |
| siloxane | | | | | | | | |
| composition 7 | | | | | | | | |
| Added | | | | | | | | |
| siloxane | | | | | | | | |
| composition 8 | | | | | | | | |
| Weight | 100 | 100 | 100 | 100 | 100 | 100 | 100 | 100 |
| siloxane | | | | | | | | |
| compound in | | | | | | | | |
| added | | | | | | | | |
| siloxane | | | | | | | | |
| based | | | | | | | | |
| composition | | | | | | | | |
| (%) | | | | | | | | |
| Siloxane | | | | | | | | |
| compound, | | | | | | | | |
| calculated | | | | | | | | |
| parameters | | | | | | | | |
| Silicon % * | 37.05 | 37.2 | 37.2 | 37.2 | 37.6 | 37.8 | 37.8 | 34.65 |
| Average | 630 | 697 | 697 | 697 | 898 | 3310 | 3310 | 162.4 |
| molecular | | | | | | | | |
| weight * | | | | | | | | |
| Average | 0 | 0 | 0 | 0 | 0 | 0 | 0 | 0 |
| number of | | | | | | | | |
| reactive | | | | | | | | |
| group/molecule * | | | | | | | | |
| Added | 1.46 | 0.06 | 0.35 | 1.46 | 0.35 | 0.35 | 1.48 | 0.06 |
| siloxane | | | | | | | | |
| compound | | | | | | | | |
| over total | | | | | | | | |
| formulation** (%) | | | | | | | | |
| Isocyanate | 300 | 300 | 300 | 300 | 300 | 300 | 300 | 300 |
| index | | | | | | | | |
| Reactivity - | 60 | 60 | 57 | 60 | 58 | 63 | 68 | 62 |
| Gel time (s) | | | | | | | | |
| Foam density | 31 | 32 | 31 | 32 | 32 | 31 | 32 | 33 |
| (kg/m³) | | | | | | | | |
| Cell | controlled | controlled | controlled | controlled | controlled | controlled | controlled | Controlled |
| size/structure | | | | | | | | |
| Thermal | | | | | | | | |
| conductivity | | | | | | | | |
| after 24 hours | | | | | | | | |
| (Lambda | 22.84 | 23.49 | 22.81 | 22.9 | 23.24 | 24.49 | 24.66 | 24.01 |
| 0-20° C., in | | | | | | | | |
| mW/K.m) | | | | | | | | |

TABLE 1c

| Foam | | | | |
|---|---|---|---|---|
| Formulation | 14 | 15 | 16 | 17 |
| Aromatic | 100 | 100 | 100 | 100 |
| polyester | | | | |
| polyol, | | | | |
| Stepanpol PS | | | | |
| 2412 | | | | |
| TCPP liquid | 15.0 | 15.0 | 15.0 | 15.0 |
| fire retardant | | | | |
| Water | 0.8 | 0.8 | 0.8 | 0.8 |
| Niax catalyst | 0.25 | 0.25 | 0.25 | 0.25 |
| C-5 | | | | |
| Niax | 2.5 | 2.5 | 2.5 | 2.5 |
| potassium | | | | |
| octoate | | | | |
| Conventional | 1.6 | 1.6 | 1.6 | 1.6 |
| rigid foam | | | | |
| silicone | | | | |
| stabilizer | | | | |
| n-pentane | 20 | 20 | 20 | 20 |
| Polymeric | 218 | 218 | 218 | 218 |
| MDI, | | | | |
| Desmodur | | | | |
| 44V70L | | | | |
| Added | | | | |
| siloxane | | | | |
| composition 1 | | | | |
| Added | | | | |
| siloxane | | | | |
| composition 2 | | | | |
| Added | | | | |
| siloxane | | | | |
| composition 3 | | | | |
| Added | | | | |
| siloxane | | | | |
| composition 4 | | | | |
| Added | 5 | | | |
| siloxane | | | | |
| composition 5 | | | | |
| Added | | 0.2 | | |
| siloxane | | | | |
| composition 6 | | | | |
| Added | | | 1.2 | |
| siloxane | | | | |
| composition 7 | | | | |
| Added | | | | 1.2 |
| siloxane | | | | |
| composition 8 | | | | |
| Weight | 100 | 100 | 87.3 | 87 |
| siloxane | | | | |
| compound in | | | | |
| added | | | | |
| composition | | | | |
| (%) | | | | |
| Siloxane | | | | |
| compound, | | | | |
| calculated | | | | |
| parameters | | | | |
| Silicon % * | 34.65 | 37.2 | 19.5** | 19.1** |
| Average | 162.4 | 830 | 720** | 740** |
| molecular | | | | |
| weight * | | | | |
| Average | 0 | 0 | 1 | 0 |
| number of | | | | |
| reactive | | | | |
| group/molecule * | | | | |
| Added | 1.46 | 0.06 | 0.31 | 0.31 |
| siloxane | | | | |
| compound | | | | |
| over total | | | | |
| formulation** | | | | |
| (%) | | | | |
| Isocyanate | 300 | 300 | 300 | 300 |
| index | | | | |
| Reactivity- | 65 | 65 | 62 | 60 |
| Gel time (s) | | | | |
| Foam density | 30 | 32 | 33 | 31 |
| (kg/m3) | | | | |
| Cell | controlled | controlled | Controlled | controlled |
| size/structure | | | | |
| Thermal | | | | |
| conductivity | | | | |
| after 24 hours | | | | |
| (Lambda | 24.2 | 23.54 | 24.26 | 23.97 |
| 0-20° C., in | | | | |
| mW/K ·m) | | | | |

Notes for Tables 1a-1c
* excluding excess polyether reactant in case of modification of the siloxane
**excluding physical blowing agent weigh

For both tables 1a-c and 3, the following silicone based composition are used:

Conventional rigid foam silicone stabilizer: A copolymer obtained from reacting a linear silicone hydride of 65 D units and 7.5 D′ units on a allyl hydroxy terminated EO/PO polyether at 30% polyether excess, the polyether contains about 12.8 EO units and 3.2 PO. The siloxane copolymer has a silicone content of about 19% and a number average molecular weight of about 11000 Dalton.
Siloxane based compositions 1 to 4 are described in table 2.
Siloxane composition 5: Hexamethyldisiloxane, or MM
Siloxane composition 6: An unmodified polydimethylsiloxane, T type of average structure M3D7T
Siloxane composition 7: Modified siloxane obtained from reacting MD [symbol] M with allyl hydroxy terminated polyethylene oxide, 6.6 EO units
Siloxane composition 8: Modified siloxane obtained from reacting MD [symbol] M with allyl methoxy terminated polyethylene oxide, 6.6 EO units

TABLE 2

| | | Low molecular weight | High molecular weight | |
|---|---|---|---|---|
| | Number | linear species present at | linear species present | |
| | average | a cumulative weight | at very low cumulative | Residual cyclic |
| | molecular | lower than 2.5% over | level over total | siloxanes D4, D5 |
| | weight* | total composition | composition **** | and D6 ***** |
| | (Dalton) | (Dalton) | (Daltons) | (weight %) |
| Siloxane | 630 | 400 and below** | 1050 and above | Below 0.5 |
| composition 1 | | | | |
| Siloxane | 697 | 400 and below** | 1180 and above | Below 0.5 |
| composition 2 | | | | |
| Siloxane | 898 | 500 and below** | 2870 and above | Below 0.5 |
| composition 3 | | | | |
| Siloxane | 3310 | 550 and below*** | 22250 and above | Below 0.5 |
| composition 4 | | | | |

Notes for Table 2
*Determined by ²⁹Si NMR as average number of D units per two M terminations
**Determined by gas chromatography, recalculated to weight % using calibration factors
***Determined by Gel Permeation Chromatography (GPC), as molecular weights contributing to less than 0.5% of the total integral on the low molecular weight side-poly dimethylsiloxane standards are used for calibration
**** Determined by Gel Permeation Chromatography (GPC), as molecular weights contributing to less than 1% of the total integral on high molecular weight side-polydimethylsiloxane standards are used for calibration
***** D4, D5 and D6 are common cyclic residual species in siloxane compositions, respectively octamethylcyclotetrasiloxane (D4), decamethylcyclopentasiloxane (D5) and dodecamethylcyclohexasiloxane (D6). The levels were obtained by liquid extraction of the compositions followed by gas chromatography of the extracted mix.

The results show that a conventional silicone surfactant incorporated at a standard level of 1.6 to 2.8 parts per 100 parts of the main polyol results in initial foam thermal conductivity values (or lambda values) in the range of 24 to 24.5 mW/m.K, foams 1a to 1c. Some standard scattering is observed with the foam without any added siloxane composition but still within the 24 to 24.5 mW/m.K range. By increasing the conventional surfactant level to very high values such as 5 parts, a marginally lower lambda value can be obtained at 23.81 mw/m.K, but it is a very small benefit considered as not highly significant. It was found that by adding, additional to the conventional silicone surfactant, a siloxane rich composition of selected molecular weight, and at a level as low as 0.2 parts per 100 parts of the main polyol or higher, significantly lower foam lambda values can be obtained. This can be seen with the added siloxane compositions 1 to 3 or 6, which fall within aspects and embodiments of the invention. Comparative examples using added siloxane compositions 4, 5, 7, or 8, which have lower or larger molecular weights or lower silicon content and are outside of the invention, did not provide such benefit. All the foams generated from these experiments are not significantly different for other basic foam characteristics such as reactivity (as quantified by the Gel time) and foam density.

Table 3 shows a typical formulation for PUR foams, e.g. made with a formulation where the calculated isocyanate excess is significantly lower than 200. For the experiment listed in Table 3, a 30% molar isocyanate excess was used, meaning an isocyanate index of 130. The blowing agent used for this formulation is cyclopentane and lambda values were measured at a mean temperature of 23° C., between 0° C. and 36° C. plate temperatures.

TABLE 3

| Foam | 2 | Ex. 18 | Ex. 19 | Ex. 20 | Ex. 21 | Ex. 22 |
|---|---|---|---|---|---|---|
| polyether | 50 | 50 | 50 | 50 | 50 | 50 |
| polyol | | | | | | |
| Daltolac | | | | | | |
| R585 | | | | | | |
| polyether | 50 | 50 | 50 | 50 | 50 | 50 |
| polyol | | | | | | |
| Voracor | | | | | | |
| RN 411 | | | | | | |
| TCPP liquid | 10.0 | 10.0 | 10.0 | 10.0 | 10.0 | 10.0 |
| fire retardant | | | | | | |
| Water | 2.0 | 2.0 | 2.0 | 2.0 | 2.0 | 2.0 |
| Niax catalyst | 2.3 | 2.3 | 2.3 | 2.3 | 2.3 | 2.3 |
| C-8 | | | | | | |
| Niax catalyst | 0.7 | 0.7 | 0.7 | 0.7 | 0.7 | 0.7 |
| A-1 | | | | | | |
| Conventional | 3.0 | 3.0 | 3.0 | 3.0 | 3.0 | 3.0 |
| rigid foam | | | | | | |
| silicone | | | | | | |
| stabilizer | | | | | | |
| Cyclopentane | 18.0 | 18.0 | 18.0 | 18.0 | 18.0 | 18.0 |
| Total B-side | 136.0 | 136.0 | 136.0 | 136.0 | 136.0 | 136.0 |
| polymeric | 177.0 | 177.0 | 177.0 | 177.0 | 177.0 | 177.0 |
| MDI low | | | | | | |
| viscosity | | | | | | |
| Added | | 1 | | | | |
| siloxane | | | | | | |
| composition 2 | | | | | | |
| Added | | | 1 | | | |
| siloxane | | | | | | |
| composition 5 | | | | | | |
| Added | | | | 1 | | |
| siloxane | | | | | | |
| composition 6 | | | | | | |
| Added | | | | | 1 | |
| siloxane | | | | | | |
| composition 7 | | | | | | |
| Added | | | | | | 1 |
| siloxane | | | | | | |
| composition 8 | | | | | | |
| Weight | — | 100 | 100 | 100 | 87.3 | 87 |
| siloxane | | | | | | |
| compound in | | | | | | |
| added | | | | | | |
| composition | | | | | | |
| (%) | | | | | | |
| Silioxane | | | | | | |
| compound, | | | | | | |
| calculated | | | | | | |
| parameters | | | | | | |
| Silicon % * | — | 37.2 | 34.65 | 37.2 | 19.5** | 19.1** |
| Average | — | 697 | 162.4 | 830 | 720** | 740** |
| molecular | | | | | | |
| weight * | | | | | | |
| Average | | 0 | 0 | 0 | 1 | 0 |
| number of | | | | | | |
| reactive | | | | | | |
| group/molecule * | | | | | | |
| Siloxane | | 0.34 | 0.34 | 0.34 | 0.34 | 0.34 |
| rich compound | | | | | | |
| over total | | | | | | |
| formulation** (%) | | | | | | |
| Isocyanate | 130 | 130 | 130 | 130 | 130 | 130 |
| index | | | | | | |
| Reactivity - | 55 | 55 | 51 | 51 | 53 | 55 |
| Gel time (s) | | | | | | |
| Foam density | 27 | 27 | 28 | 28 | 27 | 27 |
| (kg/m3) | | | | | | |
| Cell | Controlled | Controlled | Controlled | Controlled | Controlled | Controlled |
| size/structure | | | | | | |
| Thermal | | | | | | |
| conductivity | | | | | | |
| after 24 | | | | | | |
| hours | | | | | | |
| (Lambda | 24.74 | 24.23 | 24.72 | 24.34 | 24.56 | 24.79 |
| 10-36° C., in | | | | | | |
| mW/Kxm) | | | | | | |

* excluding excess polyether reactant in case of modification of the siloxane
**excluding physical blowing agent weight

These PUR formulations show a comparable effect as obtained for the PIR formulation. With the added siloxane compositions 2 and 6, which fall within the scope of aspects and embodiments of the invention, significant thermal conductivity benefit is achieved of 0.4 mW/m.K and higher versus the control foam 2. Comparative examples using added siloxane compositions 5, 7, or 8, which fall outside the invention, do not improve lambda values for siloxane composition 5 and 8 or show a marginal benefit in the order of 0.2 mW/m.K for siloxane composition 7. Again, the foams generated other basic foam characteristics such as reactivity as quantified by the Gel time and foam density are not significantly different.

Embodiments of the technology have been described above and modifications and alterations may occur to others upon the reading and understanding of this specification. The claims as follows are intended to include all modifications and alterations insofar as they come within the scope of the claims or the equivalent thereof.

What is claimed is:

1. A process for producing a polyurethane foam by reacting the different components of a formulation comprising:
a polyol;
an isocyanate;
a catalyst;
a surfactant;
a physical blowing agent; and
a siloxane rich composition of the formula M³ₐD³_{b}D⁴_{c}T_{d}Qₑ
where
M³ is a trialkyl end-cap unit R³R⁴R⁵SiO_{1/2}—;
D³ is a dialkyl unit —O_{1/2}R⁶R⁷SiO_{1/2}—;
D⁴ is a alkyl unit —O_{1/2}R⁸R⁹SiO_{1/2}—; T is —O_{1/2}Si(O_{1/2}—)₂R¹⁰;
Q is Si(O_{1/2}—)₄;
R³, R⁴, R⁶, R⁷, R⁸, and R¹⁰ are independently fluorine, phenyl, or C1 to C10 alkyl groups, eventually fluorine or phenyl partially or fully substituted;
R⁵ is fluorine; phenyl; or C1 to C10 alkyl groups optionally partially or fully substituted with fluorine or phenyl; or —R¹¹—Oₘ—(CH₂—CH₂—O)_{q}(CH₂—CH(CH₃)—O)ₚ—R¹²;
R⁹ is —R¹¹—Oₘ—(CH₂—CH₂—O)_{q}(CH₂—CH(CH₃)—O)ₚ—R¹²;
R¹¹ is C1 to C10 hydrocarbon group;
R¹² is hydrogen, phenyl, fluorine, or a C1-C8 hydrocarbon group, in embodients fluorine or phenyl partially or fully substituted and optionally interrupted by urethane, urea or carbonyl groups;
a and b are independently from 0 to 30;
c, d, and e are independently from 0 to 5;
m is 0 or 1;
q and p are independently from 0 to 10;
with the condition that b +c is at least 1;
with the proviso that the siloxane rich compound has a silicon content by weight of at least 25%.

2. The process of claim 1 where the siloxane rich compound or mixture of has a number average molecular weight between 200 and 3000 dalton.

3. The process of claim 1 where the siloxane rich compound or mixture of has a number average molecular weight between 300 and 2500 dalton.

4. The process of claim 1 where the siloxane rich compound or mixture of has a number average molecular weight between 450 and 2000 dalton.

5. The process of claim 1 where the siloxane rich compound or mixture of has a silicon content by weight above 28%.

6. The process of claim 1, wherein the siloxane rich compound or mixture of has a silicon content by weight above 28% up to 32%.

7. The process of claim 1 where the siloxane rich compound or mixture of has on average 2 or less reactive groups per molecule that can react with isocyanate.

8. The process of claim 1 where the siloxane rich compound or mixture of has on average less than 2 or no reactive groups that can react with isocyanate.

9. The process of claim 1 where subscript a of the siloxane rich compound is at least equal to 1.

10. The process of claim 1, wherein the siloxane rich composition is based on a distribution of molecular weight that contains 2.5% or less by weight of siloxane based species having a molecular weight below 400.

11. The process of claim 1, wherein the siloxane rich composition contains about 5% or less by weight of cyclic siloxane species having 3 to 6 siloxane groups selected from hexamethylcyclotrisiloxane (D3), octamethylcyclotetrasiloxane (D4), decamethylcyclopentasiloxane (D5), and dodecamethylcyclohexasiloxane (D6).

12. The process of claim 1 comprising the siloxane rich composition or mixture in an amount of at least 0.02% by weight over the total formulation components weight excluding physical blowing agents.

13. The process of claim 1 comprising the siloxane rich composition or mixture in an amount of at least 0.03% by weight over the total formulation components weight excluding physical blowing agents.

14. The process of claim 1 comprising the siloxane rich composition or mixture in an amount of at least 0.05% by weight over the total formulation components weight excluding physical blowing agents.

15. The process of claim 1 comprising the siloxane rich composition or mixture in an amount of 3% by weight or lower over the total formulation components weight excluding physical blowing agents.

16. The process of claim 1 comprising the siloxane rich compound or mixture in an amount of about 0.05% by weight to about 3% by weight over the total formulation components weight excluding physical blowing agents.

17. The process of claim 1 where the siloxane rich composition or mixture of is added in a formulated pre-blend to be mixed with a isocyanate component to produce a polyurethane foam used as thermal insulation material.

18. The process of claim 1 where the siloxane rich composition or mixture of is added as a separate component on a foam dispensing unit to produce a polyurethane foam used as thermal insulation material.

19. The process of claim 1 where the siloxane rich composition or mixture of is added to an isocyanate component to be mixed with isocyanate reactive ingredients to produce a polyurethane foam used as thermal insulation material.

20. The process of claim 1 where the siloxane rich composition or mixture of is added in the polyurethane foam formulation in addition to a surfactant, optionally siloxane containing, with the siloxane containing portion of such surfactant if present having a silicon content lower than 25% and a number average molecular weight above 2000 dalton.

21. The process of claim 1, wherein the process forms a rigid or semi-rigid polyurethane foam.

22. The process of claim 22, wherein the rigid or semi-rigid polyurethane foam has a density between 10 and 100 kg/m³ and at an isocyanate index between 100 and 500.

23. A polyurethane foam formed from the process of claim 1.

24. The polyurethane foam of claim 23, where the foam is a rigid or semi-rigid polyurethane foam has a density between 10 and 100 kg/m³ and at an isocyanate index between 100 and 500.

25. The polyurethane foam of claim 24, where the foam has an initial thermal conductivity of about 23 mW/m·K or less at a mean temperature of 0 to 30° C.

26. A thermal insulation material comprising the polyurethane foam of claim 25.

27. An article comprising the polyurethane foam of claim 23.

28. A polyurethane foam forming composition comprising:
a polyol;
an isocyanate;
a catalyst;
a surfactant;
a physical blowing agent; and
a siloxane rich composition of the formula M³ₐD³_{b}D⁴_{c}T_{d}Qₑ
where
M³ is a trialkyl end-cap unit R³R⁴R⁵SiO_{1/2}—;
D³ is a dialkyl unit —O_{1/2}R⁶R⁷SiO_{1/2}—;
D⁴ is a alkyl unit —O_{1/2}R⁸R⁹SiO_{1/2}—; T is —O_{1/2}Si(O_{1/2}—)₂R¹⁰;
Q is Si(O_{1/2}—)₄;
R³, R⁴, R⁶, R⁷, R⁸, and R¹⁰ are independently fluorine, phenyl, or C1 to C10 alkyl groups, eventually fluorine or phenyl partially or fully substituted;
R⁵ is fluorine; phenyl; or C1 to C10 alkyl groups optionally partially or fully substituted with fluorine or phenyl; or —R¹¹—Oₘ—(CH₂—CH₂—O)_{q}(CH₂—CH(CH₃)—O)ₚ—R¹²;
R⁹ is —R¹¹—Oₘ—(CH₂—CH₂—O)_{q}(CH₂—CH(CH₃)—O)ₚ—R¹²;
R¹¹ is C1 to C10 hydrocarbon group;
R¹² is hydrogen, phenyl, fluorine, or a C1-C8 hydrocarbon group, in embodients fluorine or phenyl partially or fully substituted and optionally interrupted by urethane, urea or carbonyl groups;
a and b are independently from 0 to 30;
c, d, and e are independently from 0 to 5;
m is 0 or 1;
q and p are independently from 0 to 10;
with the condition that b +c is at least 1;
with the proviso that the siloxane rich compound has a silicon content by weight of at least 25%.
